(19) United States
(12) Patent Application Publication
(10) Pub. No.: US 2007/0026883 A1
(43) Pub. Date: Feb. 1, 2007

(54) System and method for re-invitation to push-to-talk over cellular group session

(75) Inventors: Sang-Kyung Sung, Seoul (KR); Kyung-Tak Lee, Yongin-si (KR); Hyeon-Cheol Pu, Suwon-si (KR); Sung-Jin Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/493,454

(22) Filed: Jul. 26, 2006

(30) Foreign Application Priority Data
Jul. 28, 2005 (KR) 2005-69150

(51) Int. Cl. H04B 7/00; H04Q 7/20

(52) U.S. Cl. 455/518

(57) ABSTRACT

A system and method for re-invitation to a PoC group session are provided. Processes of determining non-participating group members when the group session is initiated, obtaining information about the non-participating group members, and re-inviting the non-participating group members to a corresponding ongoing group session, are performed for all non-participating group members at one time.

### CLAIM OF PRIORITY

This application claims the benefit under 35 U.S.C. §119(a) from an application entitled “SYSTEM AND METHOD FOR RE-INVITATION TO PUSH-TO-TALK OVER CELLULAR GROUP SESSION” filed in the Korean Intellectual Property Office on Jul. 28, 2005 and assigned Serial No. 2005-69150, the contents of which are incorporated herein by reference.

### BACKGROUND OF THE INVENTION

1. Field of the Invention

The present invention relates to a system and method for re-invitation to a push-to-talk (PTT) over cellular (PoC) group session, and more particularly, to a system and method for re-invitation to a PoC group session of pre-arranged group members, capable of collectively re-inviting group members who do not accept the invitation when the PoC group session is initiated.

2. Description of the Related Art

Significant developments in mobile communications technology and the extension of mobile communications networks have resulted in the development of a vast array of services and applications for use with a cellular phone. Concurrently, there is an increasing demand from cellular phone users for additional services, such as a location, multimedia and push-to-talk (PTT) service. Among these additional services, the PTT service supports various supplementary functions such as instant messenger and a status display, as well as a group call and a voice call which are also provided by an existing radio or a trunk radio system (TRS).

Meanwhile, a PTT over Cellular (PoC) service uses a mobile communication network. Standardization of the PoC service is currently taking place in the Open Mobile Alliance (OMA), a forum for specifying mobile communications services.

The PoC service also supports a group talk service. The PoC service supports a group talk function for a multilateral conference function based on half-duplex communication, as well as various types according to the purpose of a PoC group. Specifically, a PoC conference group can be divided into an ad-hoc PoC group, a pre-arranged PoC group, and a chat PoC group according to features of the group.

A session setup for group talk is performed on the group members. Thus, a PoC service subscriber can be provided with the group talk service with all of the group members without having to individually invite the group members to the session.

On the other hand, in the case of the group talk with a restricted PoC group such as a pre-arranged PoC group or a restricted chat PoC group, at least one of the group members may receive no invitation message from an initiated group session due to such an occurrence as a connection failure, or may reply to the invitation to the initiated group session with an error response. A group member who does not receive an invitation message from the initiated group session, or replies to the invitation to the initiated group session with the error response, cannot participate in the group talk. In addition, a group member may not be able to participate in the group talk because of rejection or expiration of a response time.

In this case, a method of re-inviting group members who do not participate in the PoC group talk, to the PoC group session of interest is required. Particularly, in the case of a PoC group talk in which all group members should participate, group members who do not participate should be re-invited to the PoC group session.

Conventionally, re-invitation to the PoC group session is performed by a PoC client. When re-inviting non-participating PoC clients to a PoC group session, conference information of the non-participating PoC clients is collected through a supplementary SIP message of an SIP SUBSCRIBE/NOTIFY method. Then, the collected participant information is compared with a group member list of the pre-arranged PoC group, and information on PoC addresses of corresponding PoC clients is manually added. This method of re-inviting non-participating PoC clients to the PoC group session requires that processes of a PoC service user examining a group member who does not participate in the PoC group session, selecting address information of the non-participating group member, and re-inviting the non-participating group members to the corresponding PoC group session be repeated for each non-participating group member one by one.

### SUMMARY OF THE INVENTION

It is an object of the present invention to provide a re-invitation method and system of a PoC group session, capable of re-inviting all group members who do not participate in a PoC group talk during a PoC service all at once.

According to the present invention, there is provided a system for re-invitation to a push-to-talk-over-cellular (PoC) group session. The re-invitation system includes a PoC server of a PoC system providing a group call service. The PoC server checks group members not participating in a previously established group session, obtains address information of the checked non-participating group members, and re-invites the non-participating group members to the PoC group session using the obtained address information.

According to the present invention, there is provided a system for re-invitation to a push-to-talk-over-cellular (PoC) group session, including a PoC client of a PoC system providing a group call service. The PoC client determines whether the PoC group session is a previously established session when a request to establish the PoC group session is input from a user, and creates and transmits a message containing a re-invitation parameter when the PoC group session requested for the establishment is a previously established group session.

The determination whether the PoC group session is a previously established session may be preformed by determining whether a group identity of the group session requested for the establishment is consistent with any one of group identities of previously established groups.

According to the present invention, there is provided a system for re-invitation to a push-to-talk-over-cellular (PoC) group session in a PoC system providing a group call service, including a PoC client for determining whether the PoC group session is a previously established session when a request to establish the PoC group session is input from a user, and creating and transmitting a message containing a re-invitation parameter when the PoC group session requested for the establishment is a previously established group session, and a PoC server for, when the message is received from the PoC client, determining group members who are not participating in the group session indicated by the message, and re-inviting the determined non-participating group member to the group session.

According to the present invention, there is provided a method for re-invitation to a push-to-talk-over-cellular (PoC) group session in a PoC system providing a group call service, including receiving a re-invitation request directed to group members not participating in a previously established group session, determining the non-participating group members of the group session, and inviting the non-participating group members of the group session to the group session.

The step of inviting the non-participating group members may include obtaining address information of the non-participating group members, and transmitting a message inviting the non-participating group members to the group session using the obtained address information.

### BRIEF DESCRIPTION OF THE DRAWINGS

The above and other objects, features and advantages of the present invention will be more clearly understood from the following detailed description, taken in conjunction with the accompanying drawings, in which:

FIG. 1 shows a configuration of a conventional PoC system;

FIG. 2 shows a schematic configuration of a conventional PoC server;

FIG. 3 is a schematic diagram illustrating CF and PF blocks of a PoC server;

FIG. 4 is a flowchart for a process of a PoC client performing collective PoC group session re-invitation of all PoC clients that do not participate in a PoC group session when the PoC group session is initiated;

FIG. 5 is a flowchart for a process of a PoC server performing collective PoC group session re-invitation of all PoC clients that do not participate in a PoC group session when the PoC group session is initiated;

FIG. 6 shows a PoC group session re-invitation procedure in accordance with the present invention;

FIGS. 7 and 8 illustrate a detailed format of a message through which a PoC client A requests PoC group session re-invitation from a corresponding PoC server using SIP in the procedure of FIG. 6; and

FIG. 9 illustrates an XML document of an SIP message of FIG. 6, in which the XML document includes a “poc-presettings” element and its sub-elements, “note,” “poc_reinvite,” and “reinvite-missing,” each of which is defined by a value type, an attribute type, and so on.

### DETAILED DESCRIPTION OF THE PREFERRED EMBODIMENTS

The following description is illustrative of an application of the present invention to a push-to-talk (PTT) system, particularly a PTT over cellular (PoC) system in which a PTT service is provided using a mobile communication network.

The present invention is directed to a method of establishing a PoC group session for providing an Open Mobile Alliance (OMA) PoC call service, and more particularly, to technology for collectively re-inviting group members who do not accept an invitation when a PoC group session, such as a pre-arranged group session, of pre-arranged group members is initiated.

Hereinafter, preferred embodiments of the present invention will be described with reference to the accompanying drawings. In describing the present invention, it is assumed that the basic construction and functionality of the present invention are based on a PoC Rel. 1 system, as well as Session Initiation Protocol (SIP), Extended SIP, and Extensible Mark-up Language (XML) Configuration Access Protocol (XCAP). SIP and Extended SIP, application-layer protocols for controlling Internet multimedia communication (IP telephony), are mainly used for transmitting session participation information of a PoC group talk.

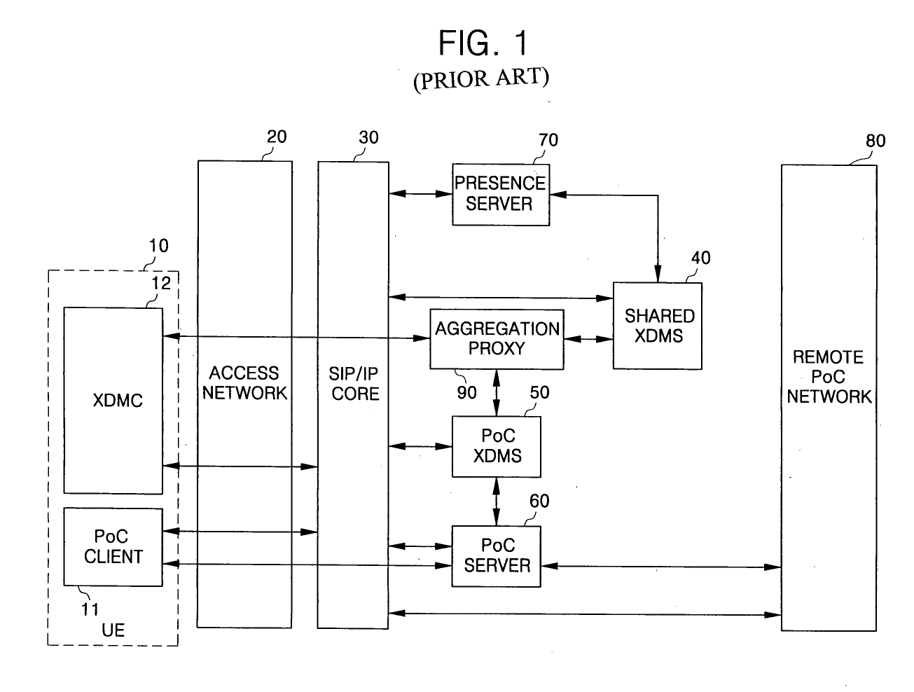

The present invention can be applied to a conventional PoC system as shown in FIG. 1. Such a PoC system can be composed of user equipment (UE) 10 acting as a PoC terminal, a PoC server 60, and XML Document Management (XDM) Servers (XDMSs) 40 and 50. The PoC system can further include a presence server 70 and an aggregation proxy 90. These entities can be connected with an access network 20 through a Session Initiation Protocol/Internet Protocol (SIP/IP) core 30 and a remote PoC network 80.

The UE 10 includes a PoC client 11 for using a PoC service, and an XDM client (XDMC) 12 for using information about a PoC group.

The PoC client 11 is a service requester that is built into the UE (hereinafter PoC terminal), and is usually connected to the SIP/IP core 30 that supports SIP and IP multimedia via the access network 20.

At this time, the PoC client 11 resides in a PoC user terminal to provide access to the PoC service. The PoC client 11 mainly serves to establish, participate in and terminate the established PoC session from the PoC user's point of view. In addition, the PoC client 11 creates and transfers a talk burst, supports an instant personal alert and performs authentication when providing access to the PoC service. Hereinafter, unless otherwise stated, the PoC client is assumed to be the same as a PoC terminal or a PoC service subscriber. Further, the PoC client receives a Real-time Transport Protocol (RTP) Control Protocol (RTCP) message transmitted to a previously established session, parses the message at an upper layer, and enables a PoC user to recognize RTP media and other call control relevant information.

Meanwhile, the PoC client can obtain and process group list information in cooperation with the XDMC 12, and establish a group session by applying SIP or Extended SIP. The XDMC 12 resides in the PoC terminal 10 and is used for a group talk service such as group session establishment. The XDMC is defined in the OMA specification.

The XDMSs 40 and 50 are servers used for a group list service. These servers are also defined in the OMA specification. The XDMSs 40 and 50 can be divided into the PoC XDMS 50 that is specific to the PoC service, and the shared XDMS 40 that is commonly used in another service enabler.

In the PoC system, the PoC user can input information about a group and its members into the XDMSs 40 and 50 through his own PoC terminal 10, and can receive information about other PoC users with whom the PoC user can talk through an individual or group list received from the XDMSs 40 and 50. Alternatively, in order to create, modify and manage the group and its members, the information about the group and its members may be input into the XDMSs 40 and 50 via a communication network, such as the Internet or an Intranet.

The aggregation proxy 90 routes a group list relevant request to each of the XDMSs 40 and 50 according to an appropriate rule when the group list relevant request is received from the XDMC 12. The protocols and details for the XDM, such as creating, modifying and deleting the group list, are well-known among those of skill in the art, and so their detailed description will be omitted.

The SIP/IP core 30 is connected to the XDMSs 40 and 50, the PoC server 60, and the presence server 70 in order to support the PoC service.

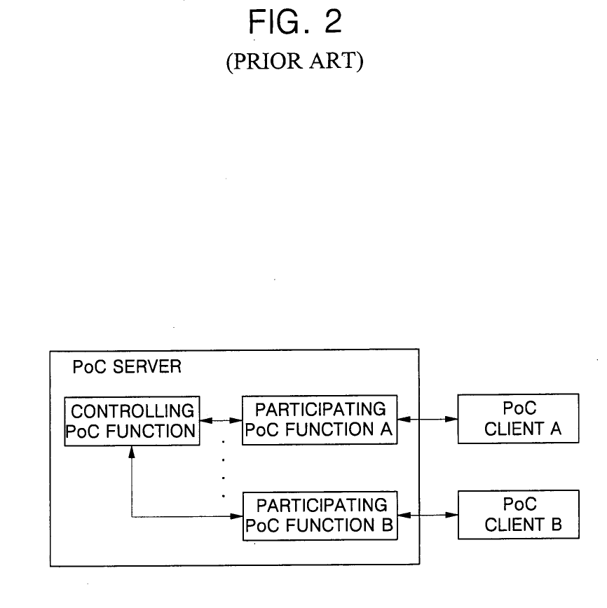

The PoC server 60 has a Controlling PoC Function for maintaining and managing the PoC session, or a Participating PoC Function for participating in the PoC session for a one-to-one PoC call or a one-to-two or more PoC call (or a group PoC call). The PoC server 60 can act as the CF or PF according to whether it owns a group session. Functional blocks in the PoC server 60 will be described with reference to FIG. 2.

FIG. 2 shows a schematic configuration of a conventional PoC server.

The PoC server 60 performs both a Controlling PoC Function (hereinafter CF) of controlling overall maintenance and management of a PoC session, and/or a Participating PoC Function (hereinafter PF) of controlling maintenance and management between each PoC session, which will be explained below with reference to Tables 1 and 2.

Table 1 shows functions of the PoC server 60 when performing the CF.

TABLE 1
Controlling PoC Function (CF)

Provides centralized PoC session handling
Provides centralized Media distribution
Provides centralized Talk Burst Arbitration functionality
including talker identification
Provides SIP session handling, such as SIP session origination,
termination, etc.
Provides policy enforcement for participation in group sessions
Provides participant information
Collects and provides centralized media quality information
Provides centralized charging reports
May provide transcoding between different codecs
Supports Talk Burst Control Protocol Negotiation

As shown in Table 1, the PoC server performing the CF (or the Controlling PoC server) serves to manage a PoC session. In particular, the Controlling PoC server receives requests for the floor from PoC clients, arranges an order in which to give the clients the floor, and gives the clients the floor in that order. The Controlling PoC server also distributes a talk burst, for which an arbitrary PoC client makes a request, to all other PoC clients participating in a group PoC call, and provides information of the PoC clients participating in the group PoC call.

Table 2 shows functions of the PoC server 60 when performing the PF.

TABLE 2
Participating PoC Function (PF)

Provides PoC session handling
May provide the Media relay function between PoC client and
Controlling PoC server
May provide user media adaptation procedures
May provide the Talk Burst control message relay function
between PoC client and Controlling PoC server
Provides SIP session handling, such as SIP session origination,
termination, etc, on behalf of the represented PoC client
Provides policy enforcement for incoming PoC session (e.g. access
control, incoming PoC session barring, availability status, etc.)
May collect and provide media quality information
Provides participant charging reports
May provide filtering of media streams in the case of
simultaneous sessions
May provide transcoding between different codecs
May support Talk Burst Control Protocol Negotiation
Stores the current Answer Mode and Incoming PoC Session
Barring preferences of the PoC client

As shown in Table 2, the PoC server performing the PF (or the Participating PoC server) manages PoC sessions interconnected between the Controlling PoC server and each PoC client. In particular, the Participating PoC server relays the floor between the PoC client and the Controlling PoC server when the PoC client requests the floor or when the Controlling PoC server gives the floor to the PoC client. In addition, the Participating PoC server relays media between the Controlling PoC server and the PoC client, performs transcoding of different codecs used between the Controlling PoC server and the PoC client, and filters one of two concurrent PoC sessions according to the choice of a PoC user when there is simultaneous talking in the two active PoC sessions.

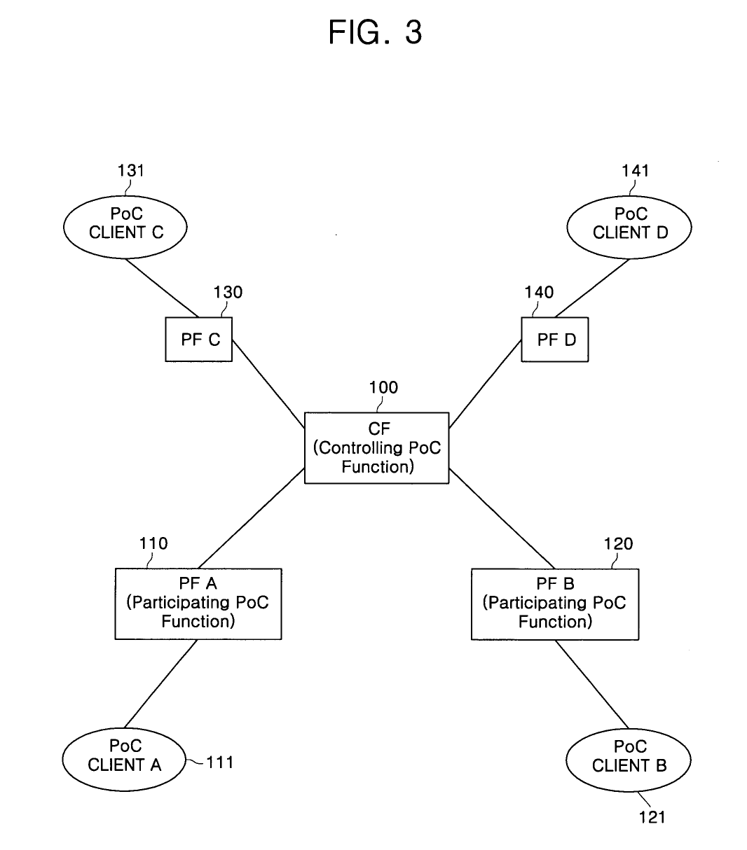

FIG. 3 is a schematic diagram illustrating CF and PF blocks of a PoC server.

As shown in FIG. 3, PoC clients 111, 121, 131 and 141 provide access to a CF 100 through PFs 110, 120, 130 and 140, respectively, thereby establishing a PoC session. Here, when the floor is granted to a requester qualified as a talker from the CF 100, speech media of the corresponding PoC client is transmitted to each PoC client. At this time, the PoC user who is granted the floor cannot appropriately speak until he/she confirms information of the participants participating in the PoC group session.

Next, a procedure of establishing the PoC group session, which can be performed in the foregoing PoC system, will be described.

In order to use the PoC service, the PoC user registers his/her PoC address with the SIP/IP core 30. The SIP/IP core 30 stores information about the PoC user by request of the PoC user. Thus, when any PoC user tries to request a group PoC call, the PoC user registers his/her information with the SIP/IP core 30 in advance, and requests the group PoC call from his/her SIP/IP core 30 by using group identification information transmitted from the XDMS 40. At this time, the SIP/IP core 30 performs addressing and domain locating of a corresponding PoC user using information of the PoC user belonging to the requested PoC group, and then transfers a request for the PoC call to a home PoC server 60 with which the corresponding PoC user is registered. When receiving the PoC call request, the PoC server 60 prepares to establish a PoC session.

The PoC server 60 obtains information of each requested PoC user from the XDMS 40, and then transfers a PoC call request signal to a corresponding SIP/IP core 30. Here, when the PoC call request is made to PoC users within an Intradomain, the PoC server 60 performs both the CF and the PF. The PoC server 60 managing the call-requested PoC user requests the PoC call from the PoC user after locating the SIP/IP core 30 by use of the PoC user's information transmitted thereto.

A process of establishing the PoC group session in the PoC system has been described above. Re-invitation to the PoC group session according to the present invention targets any group member who does not participate in the group session in the process of establishing the PoC group session.

Re-invitation to the PoC group session according to the present invention can be considered with respect to each of the PoC client and PoC server. The PoC server should be able to detect any non-participating group member as well as invite the detected non-participating group member to the PoC group session, and the PoC client should be able to request the PoC group session re-invitation from the PoC server.

First, the PoC group session re-invitation of the PoC client side will be described.

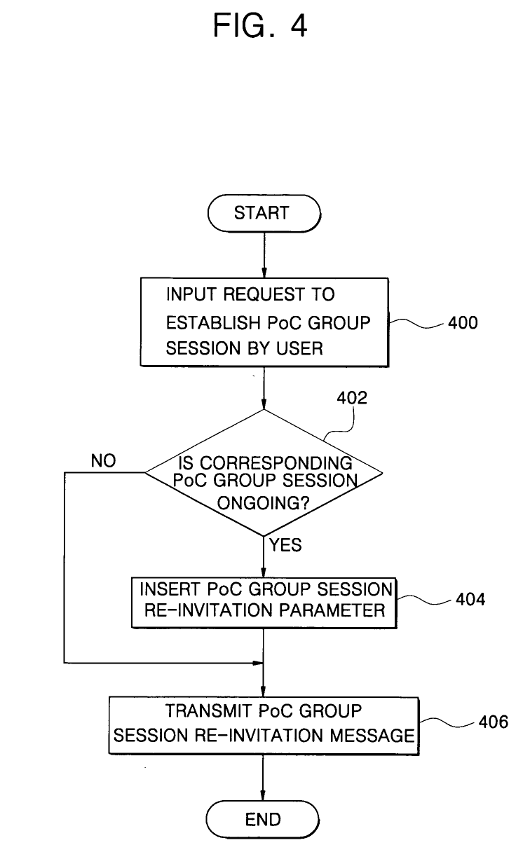

FIG. 4 is a flowchart for a process of a PoC client performing PoC group session re-invitation where all PoC clients that do not participate in a PoC group session when the PoC group session is initiated are re-invited together.

A PoC client is requested to establish a PoC group session by a user (400). When the establishment of the PoC group session is requested by the user, the PoC client determines whether the PoC group session of a corresponding PoC group from which the PoC group session establishment is requested is ongoing using an identity of the corresponding PoC group (402). To this end, the PoC client determines whether any one of identities (e.g. uniform resource identifiers (URIs)) of PoC groups of each ongoing PoC session matches that of the PoC group from which the PoC group session establishment is requested. If there is a match, the PoC client determines that the PoC group session of the PoC group from which the PoC group session establishment is requested is ongoing.

When the same identity as the PoC group of the ongoing PoC group session is requested, the PoC client creates a PoC group session re-invitation message, which contains a parameter indicating PoC group session re-invitation (404), and transmits the created PoC group session re-invitation message (406). The PoC group session re-invitation message is generally realized as an SIP message.

Meanwhile, when the PoC group session of the corresponding PoC group is not ongoing, the PoC client transmits a PoC group session invitation message into which no re-invitation parameter is inserted. In this case, a procedure of establishing a conventional PoC group session is performed.

The message transmitted by the PoC client is sent to a PoC server through mobile communication networks such as a radio access network and an SIP/IP core. An operation of the PoC server that receives the PoC group session re-invitation message from the PoC client will be described below.

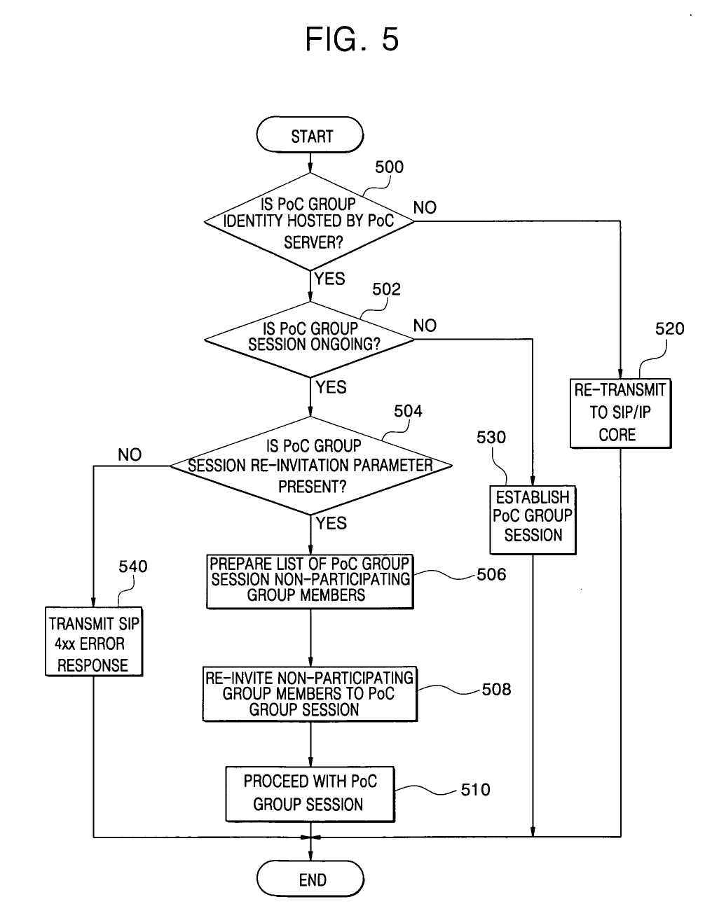

FIG. 5 is a flowchart for a process of a PoC server which receives a PoC group session re-invitation message from a PoC client, and performs collective PoC group session re-invitation of all PoC clients that do not participate in a PoC group session when the PoC group session is initiated.

When receiving a PoC group session re-invitation message from a PoC client, a PoC server determines whether a corresponding PoC group is a group hosted by the PoC server (500). To this end, the PoC server determines whether a PoC group identity contained in the received message is the identity of a group the PoC server solely hosts. If the PoC server determines that it does not host the corresponding PoC group, the PoC server re-transmits the PoC group session re-invitation message of the corresponding PoC group to the SIP/IP core (520).

If the PoC group identity contained in the received message is the identity of a group hosted by the PoC server, the PoC server determines whether the PoC group session requested through the message is ongoing (502). If the PoC group session of the corresponding PoC group is not ongoing, the PoC server establishes the PoC group session (530).

Meanwhile, when the corresponding PoC group session is previously established, the PoC server determines whether there is a PoC group session re-invitation parameter in the received message (504). If there is no PoC group session re-invitation parameter in the received message, the PoC server transmits an SIP 4XX error response (540). At this time, the PoC server may request to refresh the PoC group session without transmitting the SIP 4XX error response.

The PoC server, which requests establishment of the corresponding PoC group session and which receives the message in which the PoC group session re-invitation parameter is contained, compares the group members who have previously participated in the corresponding PoC group session with those having the requested PoC group identity, obtains information about non-participating PoC clients, and prepares a list of the non-participating PoC clients (506). At this time, a CF (i.e. a PoC server performing a Controlling PoC Function) can manage information about the clients participating in the PoC group session, since it serves as a conference server. Next, the PoC server can transmit the PoC group session re-invitation message to the PoC clients that wish to participate in the PoC group session using the obtained information of the non-participating PoC clients, and thus re-invite the non-participating PoC group members to the corresponding PoC group session (508). Meanwhile, the previously participating PoC client can be notified of an SIP message request of the non-participating PoC client by the CF, and then receive a 200 OK response from the non-participating PoC client, so that an extended PoC group session proceeds (510).

Meanwhile, in the first determination step, if the Request URI is not the PoC group URI hosted by the PoC server (500), the PoC server forwards the PoC group session re-invitation message of the corresponding PoC group to the SIP/IP core (520). In the second determination step, if the PoC group session is not the ongoing PoC group session (502), the PoC server establishes the PoC group session without additionally checking the PoC group session re-invitation parameter according to the general procedure (530). Finally, in the third determination step, if no PoC group session re-invitation parameter exists (504), this corresponds to a request for the same PoC group session as the ongoing PoC group session, and thus the PoC server may request to refresh the PoC group session or respond with the SIP 4XX error response (540).

A preferred embodiment in which the present invention is applied to a PoC group talk of a pre-arranged PoC group having four group members will now be described. However, the present invention is not limited to the details of this preferred embodiment, such as the number of group members.

Here, a call processing procedure for a first PoC group session setup will be omitted. The call processing procedure for the first PoC group session setup is the same as in the conventional PoC system.

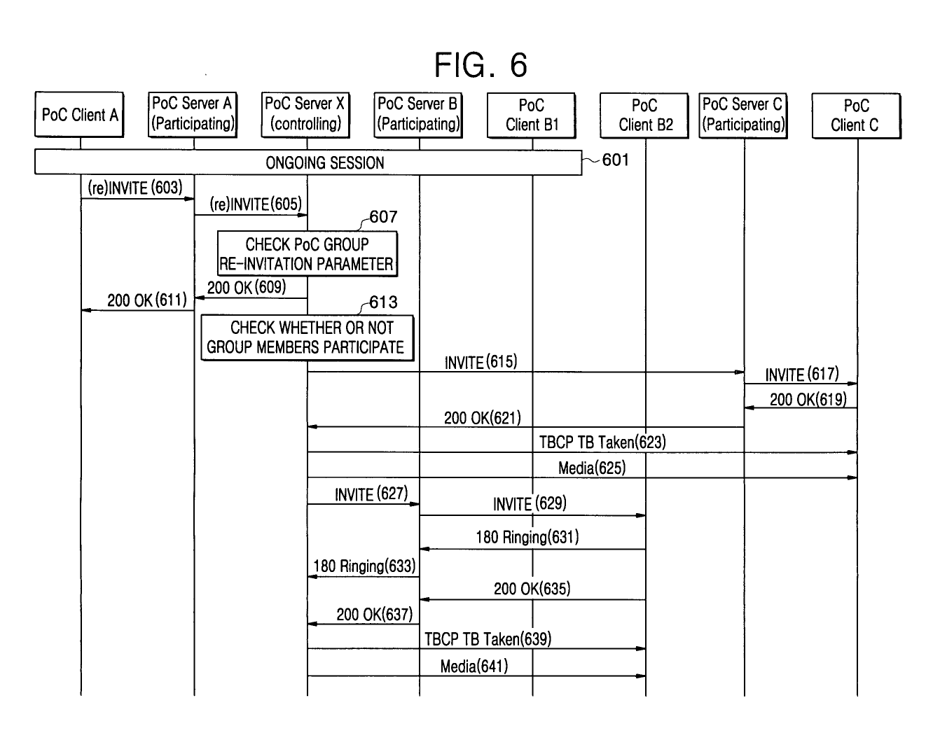

FIG. 6 shows a PoC group session re-invitation procedure in accordance with the present invention.

In the following description, a PoC client will be referred to in short as a “client.” In FIG. 6, clients A, B1, B2 and C are members of one pre-arranged group. It is assumed that, among the four clients shown in FIG. 6, client A requests establishment of a PoC group session, and client B1 participates in the PoC group session. Further, clients B2 and C are members of the group but do not participate in the PoC group session.

In FIG. 6, the PoC group session is ongoing between clients A and B1 (601).

The client A transmits an SIP INIVTE message including the same PoC group identity in order to establish the PoC group session including the non-participating clients B2 and C that do not respond when the previous PoC group session is requested (603 and 605).

At this time, the SIP INVITE message is transmitted as a re-INVITE message or a new INVITE message, which equally uses a dialog identifier of the previously established PoC group session, and is transmitted to a corresponding PoC server by information on the PoC group identity and filter criteria of an IP Multimedia Subsystem (IMS) network. In FIG. 6, the PoC server X does not designate a specific server, but may correspond to any server such as a PoC server A, B or C, which is dependent on whether each server hosts the corresponding PoC group identity.

The PoC server receiving the SIP message determines a PoC group identity and a PoC group session re-invitation parameter from the received message (607). When the PoC group identity is contained in the received message and indicates a group belonging to a domain of the PoC server, and when the PoC group session re-invitation parameter exists in the received message, the PoC server transmits a 200 OK message to the originating client A (609 and 611).

After responding with the 200 OK message, the PoC server determines conference information of the PoC group session and whether there is any non-participating client among the group members having the PoC group identity, and obtains information about corresponding clients (e.g. clients B2 and C of FIG. 6) (613). The PoC server transmits a session invitation message to the corresponding clients using the obtained information (e.g. a PoC address) (615 and 617). A procedure of processing the PoC group session after step 617 is the same as in the ordinary SIP session establishment and floor control procedure, and thus its description will be omitted.

Next, a format of the message that the client transmits to the PoC server for re-invitation to the PoC group session will be described. Particularly, a session re-invitation parameter contained in the message will be described herein. The session re-invitation parameter can be included as an attribute parameter of “Talk Burst Control Protocol (TBCP),” an application media type, introduced in the PoC service, or as an XML Multipurpose Internet Mail Extensions (MIME) type using a newly designated XML schema value. In addition, when the session re-invitation parameter is designated as the XML MIME type, the PoC session re-invitation method can be applied as a more extended method such as a session establishment procedure using a REFER message.

Examples of the message used for the above-mentioned PoC group session re-invitation will now be described with reference to the attached drawings.

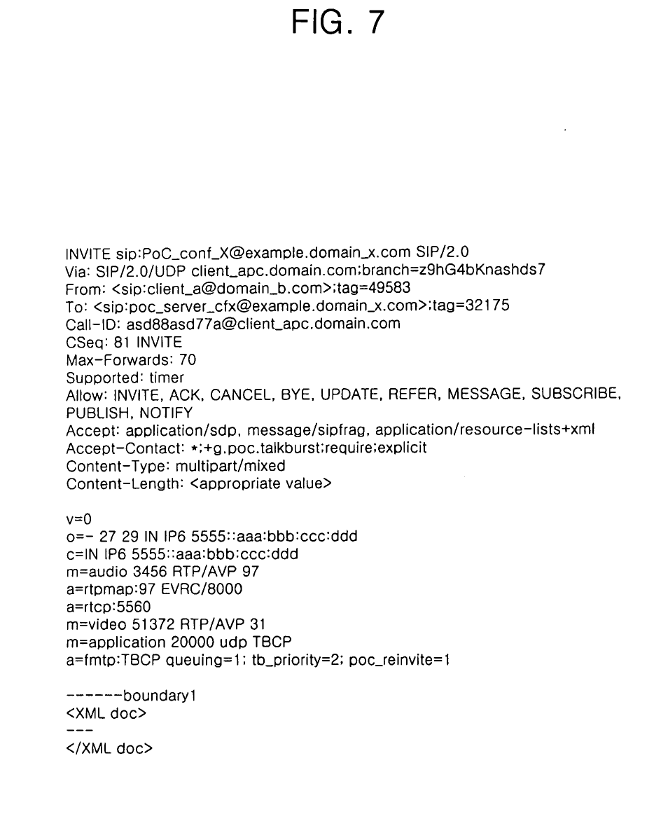

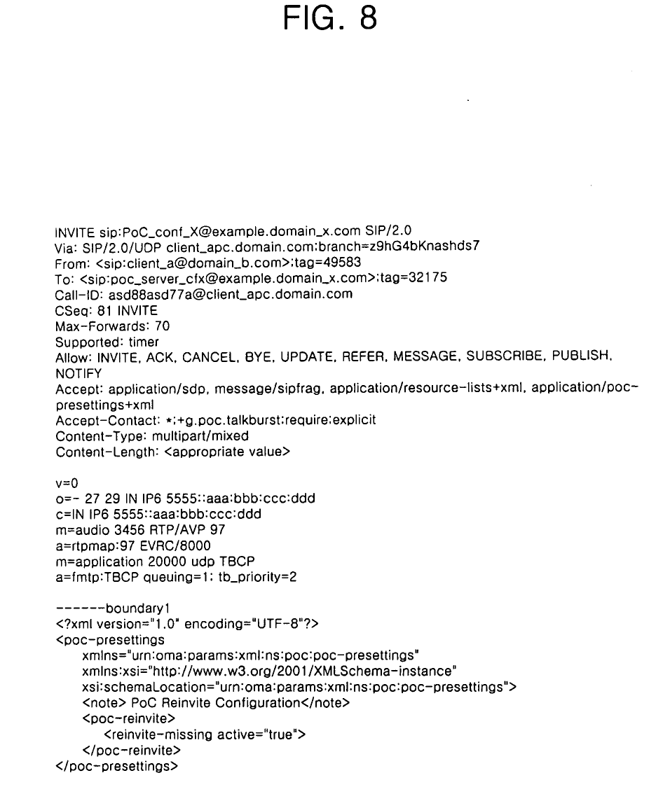

FIGS. 7 and 8 illustrate a detailed format of a message through which a PoC client A requests PoC group session re-invitation from a corresponding PoC server using SIP in a procedure of FIG. 6.

FIG. 7 illustrates a re-INVITE message when a session re-invitation parameter is provided as “plain/text.”

It is important in FIG. 7 that the session re-invitation parameter used in a re-INVITE message is expressed as an SIP Description Protocol (SDP) offer contained in a portion of an MIME. The MIME portion is expressed as “plain/text,” and offers the session re-invitation parameter as “poc_reinvite” to a PoC server that acts as a User Agent Server (UAS) as well as negotiates on parameters of various media bearers such as an audio, a video and a text. At this time, when a value of “poc_reinvite” is 1, it refers to a message for requesting session re-invitation. When the value is 0 or there is no parameter, there is no session re-invitation. Further, when an answer value of the offer is given 1 as a response, the PoC server can inform that the non-participating clients can be successfully extracted and invited to the PoC group session. Meanwhile, the re-INVITE message used for the session re-invitation in FIG. 7 is intended to change an ongoing PoC group session having the same PoC group identity, and thus the dialog information of an existing PoC session is used again. Therefore, From, To, and Call-ID tags use information about the conventional PoC session.

FIG. 8 illustrates a detailed format of a re-INVITE message when a session re-invitation parameter is provided as an XML document.

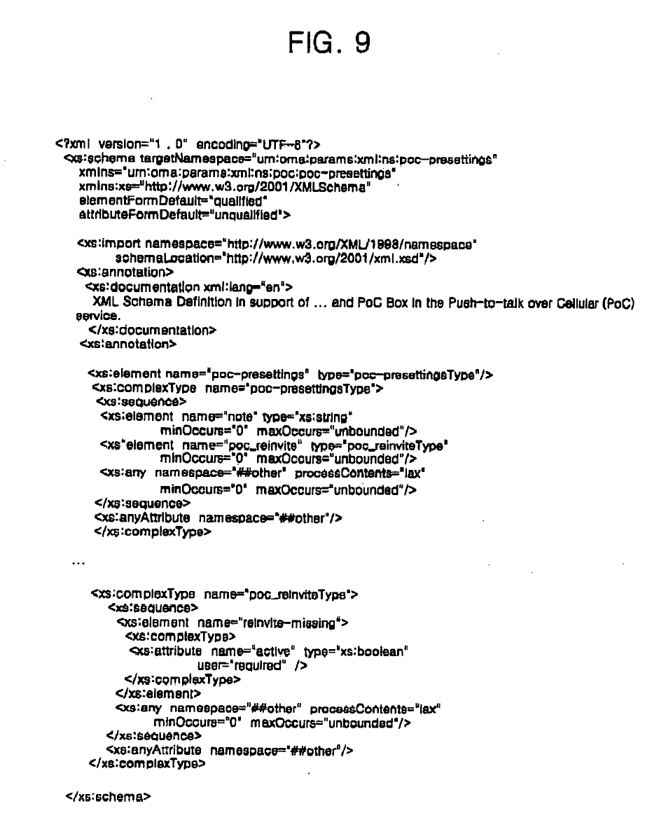

In order to include the parameter of the session re-invitation in an SIP message in the form of XML document, a new XML schema should be set for compatibility between conventional SIP protocol supporting systems, which is illustrated in FIG. 9. Meanwhile, a session re-invitation parameter is contained in a portion of an MIME as in FIG. 7, but is expressed as an XML document. In FIG. 8, the session re-invitation parameter “reinvite_missing” is included in a sub-element of a “poc-presettings” section newly defined in the XML document. A value of “reinvite_missing” is given in binary using the format of “Boolean.” When a value of “active” as an element attribute is given as “true,” the PoC group session re-invitation is requested.

FIG. 9 illustrates an XML document of an SIP message of FIG. 6, in which the XML document includes a “poc-presettings” element and its sub-elements of “note,” “poc_reinvite,” and “reinvite-missing,” each of which is defined by such parameters as a value type and an attribute type.

A PoC service element defined as “poc-presettings” is defined by sub-elements, and thus can be extended into various services including “poc_reinvite.” An attribute value of the PoC group session requested by the PoC user is assigned, so that it is possible to give a function of re-arranging participants of the ongoing PoC group session so as to comply with the attribute of the PoC group. For example, a requested filter value is set for a domain name of address information, and thereby only the client having a specific domain value is allowed to participate, or only the PoC client terminal is allowed to participate. Other machines such as a PoC Box can perform session refresh with a filter indication during the ongoing PoC group session even when being released. In this case, the same algorithm as in the foregoing group session re-invitation can be applied.

As another embodiment of the present invention, when using the XML document for the session re-invitation parameter setup, the SIP message may use a REFER message rather than the re-INVITE message. At this time, the PoC group session can be established by including the parameter of the XML format in the MIME portion of the message.

The present invention is directed to a parameter of group session re-invitation, and functions of PoC client and server supporting the parameter. Thus, use of the proposed method and system can reduce troublesome tasks such as preparation of a corresponding reception list when session participants are checked or re-invited.

While the present invention has been described with reference to preferred embodiments thereof, it should be understood by those skilled in the art that the provided embodiments may be modified in various ways without departing from the spirit and scope of the present invention as defined in the following claims.

What is claimed is:

1. A system for re-invitation to a push-to-talk-over-cellular (PoC) group session, the re-invitation system comprising:
a PoC server of a PoC system providing a group call service,
wherein the PoC server:
determines group members who are not participating in a previously established group session;
obtains address information of the non-participating group members; and
re-invites the non-participating group members to the PoC group session using the address information.

2. The re-invitation system according to claim 1, wherein the non-participating group members are determined in response to a session re-invitation request of a PoC client.

3. The re-invitation system according to claim 2, wherein the session re-invitation request of the PoC client is performed by transmission of a message including a re-invitation parameter.

4. The re-invitation system according to claim 3, wherein the message is a Session Initiation Protocol (SIP) session invitation message including the re-invitation parameter.

5. The re-invitation system according to claim 1, wherein the re-invitation of the non-participating group members is performed by re-transmitting a session invitation message to each non-participating group member.

6. A system for re-invitation to a push-to-talk-over-cellular (PoC) group session, the re-invitation system comprising:
a PoC client of a PoC system providing a group call service,
wherein the PoC client:
determines whether the PoC group session is a previously established session when a request to establish the PoC group session is input from a user; and
creates and transmits a message including a re-invitation parameter when the PoC group session requested for the establishment is a previously established group session.

7. The re-invitation system according to claim 6, wherein the message is a Session Initiation Protocol (SIP) session invitation message including the re-invitation parameter.

8. The re-invitation system according to claim 6, wherein the step of determining whether the PoC group session is a previously established session is preformed by determining whether a group identity of the group session requested for the establishment is consistent with any one of group identities of previously established groups.

9. A system for re-invitation to a push-to-talk-over-cellular (PoC) group session in a PoC system providing a group call service, the re-invitation system comprising:
a PoC client for determining whether the PoC group session is a previously established session when a request to establish the PoC group session is input from a user, and creating and transmitting a message including a re-invitation parameter when the PoC group session requested for the establishment is a previously established group session; and
a PoC server for, when the message is received from the PoC client, determining group members who are not participating in the group session indicated by the message, and re-inviting the non-participating group members to the group session.

10. The re-invitation system according to claim 9, further comprising a group information management server for providing group information to the PoC client and the PoC server.

11. A method for re-invitation to a push-to-talk-over-cellular (PoC) group session in a PoC system providing a group call service, the method comprising the steps of:
receiving a re-invitation request directed to group members who are not participating in a previously established group session;
determining the non-participating group members of the group session; and
inviting the non-participating group members to the group session.

12. The method according to claim 11, wherein the step of receiving the re-invitation request comprises transmitting a message including a re-invitation parameter of a group.

13. The method according to claim 12, wherein the message is a Session Initiation Protocol (SIP) session invitation message.

14. The method according to claim 13, wherein the message is created and transmitted by a PoC client.

15. The method according to claim 11, wherein the step of determining the non-participating group members comprises using an identifier of the group members.

16. The method according to claim 11, wherein the step of inviting the non-participating group members comprises:
obtaining address information of the non-participating group members; and
transmitting a message inviting the non-participating group members to the group session using the obtained address information.

17. The method according to claim 16, wherein the address information of the non-participating group members is obtained from a group information management server.
